(19) United States
(12) Patent Application Publication
(10) Pub. No.: US 2012/0166497 A1
(43) Pub. Date: Jun. 28, 2012

(54) APPARATUS AND METHOD FOR ESTABLISHING DATABASE AND PROCESSING USER INTERFACE FOR MONITORING BUILDING INFORMATION IN REMOTE BUILDING CONTROL SYSTEM

(75) Inventors: Chang-Sic CHOI, Daejeon (KR); Wan Ki Park, Daejeon (KR); Jinsoo Han, Daejeon (KR); Youn Kwae Jeong, Daejeon (KR); Il Woo Lee, Daejeon (KR)

(73) Assignee: Electronics and Telecommunications Research Institute, Daejeon (KR)

(21) Appl. No.: 13/332,073

(22) Filed: Dec. 20, 2011

(30) Foreign Application Priority Data
Dec. 22, 2010 (KR) 10-2010-0132061

(51) Int. Cl. G06F 17/30; G06F 3/01

(52) U.S. Cl. 707/805; 707/E17.005

(57) ABSTRACT

An apparatus for establishing a database and processing a user interface for monitoring building information in a remote building control system includes: a database establishing apparatus for receiving building information collected from at least one building and analyzing the received information and storing the building information in respective databases by position, equipment and time. The apparatus further includes a user interface processing apparatus for collecting object information from the respective databases in response to an inputted monitoring request to generate display information based on the collected object information to output the generated display information.

### CROSS-REFERENCE(S) TO RELATED APPLICATION(S)

The present invention claims priority of Korean Patent Application No. 10-2010-0132061, filed on Dec. 22, 2010, which is incorporated herein by reference.

### FIELD OF THE INVENTION

The present invention relates to a technology of managing and operating a building using a remote building control system, and more particularly, to an apparatus and method for establishing a database and processing a user interface for providing a consistent view for building management and for providing a monitoring interface from various point of views in a remote building control system, thereby, optimally managing a building operation for, e.g., saving energy or the like.

### BACKGROUND OF THE INVENTION

Recently, demands on the climatic change convention based on reducing carbon discharge and a green technology for low carbon green growth are increasing worldwide. In particular, various studies on green technologies that may be applied to buildings that consume a large amount of energy are being conducted.

Especially, technologies of saving energy by optimally operating various BAS (Building Automation system) equipments such as a cooling and heating air conditioning system, a power system, a lighting system, or the like based on cooling and heating source in a building are actively studied and applied. Recently, a research for a BEMS (Building Energy Management System) technology of studying an energy reducing technology from a comprehensive point of view of operating a building by adding various sensors is being progressed.

Such technologies are intended for finding optimal operating modes for separate buildings. However, it is difficult to apply the technologies to a large number of buildings due to large cost and lack of BEMS technicians. Efforts to collectively apply the BEMS in the remote control center in order to solve the above problems are being made.

In a building remote control system, a monitoring view is performed in order to apply the BEMS to each of the buildings. However, in the conventional simple building operation, it is difficult to effectively monitor and analyze the buildings in different environments and a problem of performance may be caused during monitoring and analyzing due to a large amount of data in managing a large number of buildings.

That is, the conventional remote building control system monitors and analyzes building data, and establishes operation measures for the buildings operated in various kinds of BAS/BEMS environments. However, with the conventional monitoring and user interface limitedly applied for operating the building equipment, many problems may be caused in optimal building operation for, e.g., saving energy.

### SUMMARY OF THE INVENTION

In view of the above, the present invention provides an apparatus and method for establishing a database and processing a user interface for providing a consistent view for building management and for providing a monitoring interface from various point of views in a remote building control system, thereby, optimally managing a building operation for, e.g., saving energy or the like.

Further, the present invention provides a method of establishing a database by position, equipment, and time for high performance processing building data in order to provide consistent and various views to a remote control center operator, and an apparatus and method for establishing a database and processing a user interface for monitoring building information in a remote building control system that can provide a user interface processing apparatus based on the established database.

In accordance with an aspect of the present invention, there is provided an apparatus for establishing a database and processing a user interface for monitoring building information in a remote building control system. The apparatus includes: a database establishing apparatus for receiving building information collected from at least one building and analyzing the received information and storing the building information in respective databases by position, equipment, and time; and a user interface processing apparatus for collecting object information from the respective databases in response to an inputted monitoring request to generate display information based on the collected object information to output the generated display information.

In accordance with another aspect of the present invention, there is provided a method for establishing a database and processing a user interface for monitoring building information in a remote building control system. The method includes: receiving, at a database establishing apparatus, building information collected from at least one building and analyzing the received information and storing the building information in respective databases by position, equipment, and time; and collecting, at a user interface processing apparatus, object information from the respective databases in response to an inputted monitoring request to generate display information based on the collected object information, and outputting the generated display information.

### BRIEF DESCRIPTION OF THE DRAWINGS

The objects and features of the present invention will become apparent from the following description of embodiments, given in conjunction with the accompanying drawings, in which:

FIG. 1 is a block diagram illustrating the configuration of a database establishing apparatus for establishing a database of building information in a remote building control system in accordance with an embodiment of the present invention;

FIG. 2 is a block diagram illustrating the configuration of a user interface processing apparatus in the remote building control system in accordance with the embodiment of the present invention;

FIG. 3 is a view illustrating an internal configuration of a database by position in accordance with the embodiment of the present invention;

FIG. 4 is a view illustrating an internal configuration of a database by time in accordance with the embodiment of the present invention;

FIG. 5 is a view illustrating an internal configuration of a database by equipment in accordance with the embodiment of the present invention; and

FIGS. 6A to 6C are views illustrating examples of a method of operating a building monitoring view generator in the user interface processing apparatus in accordance with the embodiment of the present invention.

### DETAILED DESCRIPTION OF THE EMBODIMENT

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, embodiments of the present invention will be described in detail with reference to the accompanying drawings which form a part hereof.

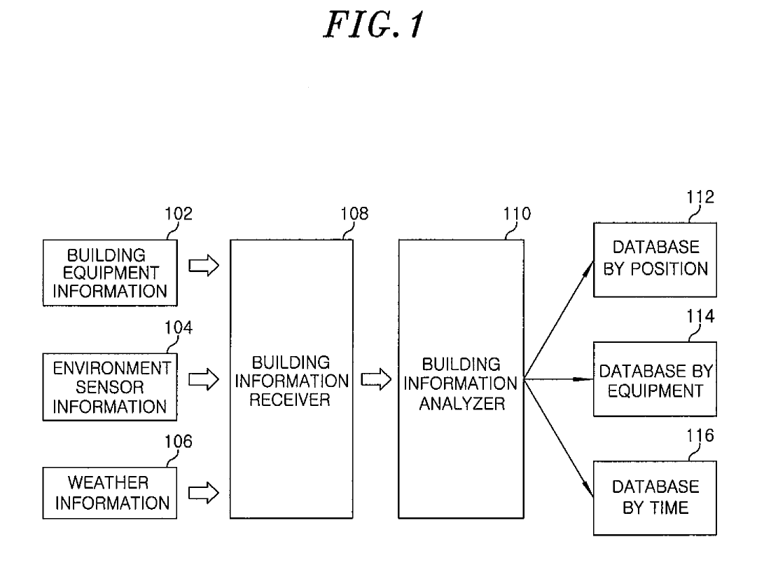

FIG. 1 is a block diagram illustrating the configuration of a database establishing apparatus for establishing a database of building information in a remote building control system in accordance with an embodiment of the present invention.

Referring to FIG. 1, the database establishing apparatus in the remote building control system includes a building information receiver 108, a building information analyzer 110, at least one database, and the like. The database establishing apparatus stores building related data collected from a remote building, the Internet, and the like in the form of the database.

More specifically, building information to be established in the database includes building equipment information 102 received from BAS equipment such as cooling and heating air conditioning equipment, lighting equipment, the power equipment and the like of a building to be remotely managed and environment sensor information 104 such as temperature, humidity, CO₂ or the like received from environment sensors in and outside the building. The building information further includes weather information 106 indicating weather information around the building collected through the Internet or the like. Such building information may be received by the building information receiver 108.

That is, the building information receiver 108 receives the building equipment information 102, the environment sensor information 104, the weather information 106 and the like from multiple buildings. The received building information may be in the form of <object information, position information, time information, and state value>.

Herein, when a client which collects the building information is provided in each of the buildings, the building information may be received in the form of <the object information, position information, time information, and state value>. However, when the building information is received from separate buildings having the BAS/BEMS environments without the client, the received building information may be converted into the form of <object information, position information, time information, and state value> by the building information receiver 108. Then, the building information receiver 108 transmits the converted building information and the received information from the client in each building to the building information analyzer 110. The building information analyzer 110 analyzes the received building information to classify the analyzed building information into a database by position 112, a database by equipment 114, and a database by time 116, so as to be stored therein.

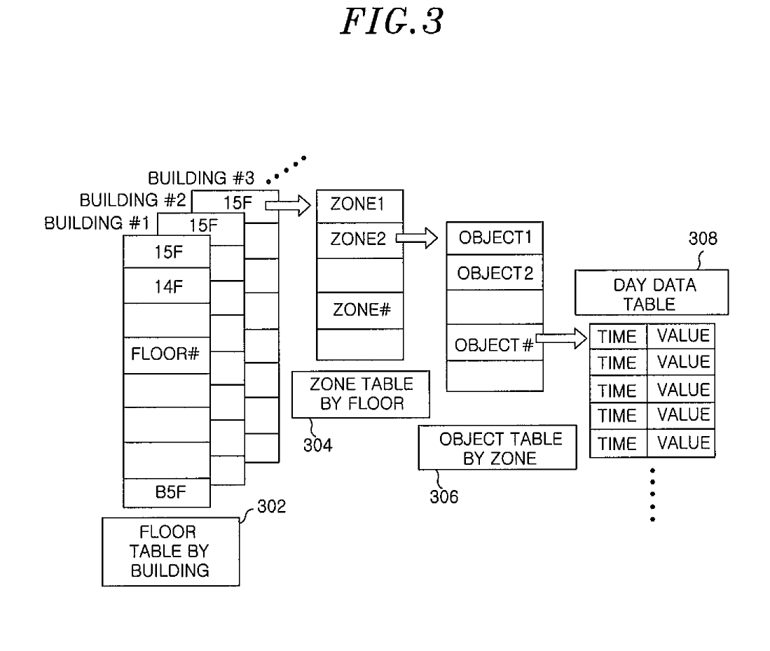

The information stored and configured in the database by position 112, the database by equipment 114, and the database 116 by time will be described in detail with reference to FIGS. 3 to 5.

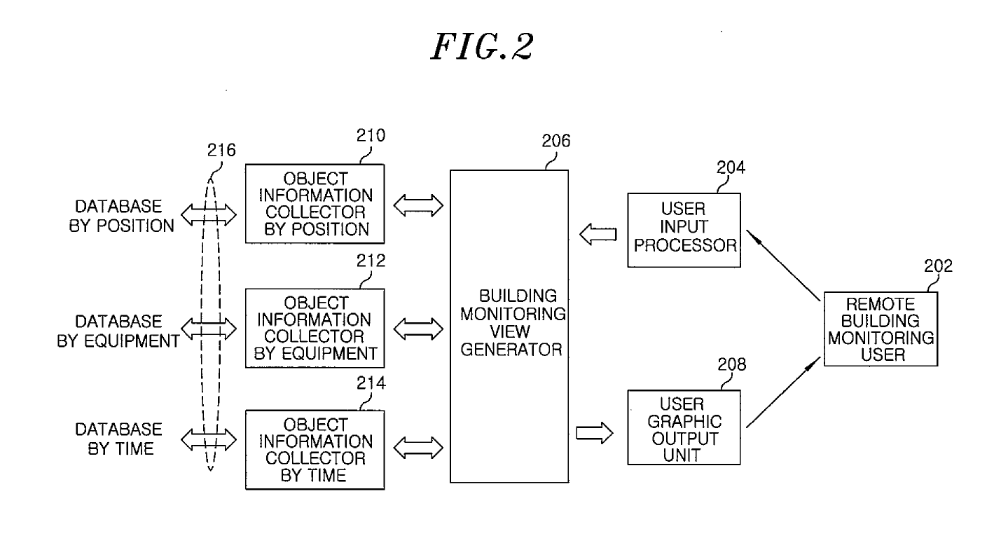

FIG. 2 is a block diagram illustrating the configuration of a user interface processing apparatus in the remote building control system in accordance with the embodiment of the present invention.

Referring to FIG. 2, the user interface processing apparatus in the remote building control system includes at least one object information collector, a building monitoring view generator 206, a user graphic output unit 208, a user input processor 204 and the like. The user interface processing apparatus generates various views and information for monitoring to transmit the same from the databases by position, by equipment, and by time 112, 114, and 116 to a user 202 monitoring remote buildings.

The user 202 selects a building to be monitored or analyzed, and the type and range of a view. Such a user request is received and analyzed by the user input processor 204 and is transmitted to the building monitoring view generator 206 as a control command.

The building monitoring view generator 206 requests an object information collector by position or equipment 210 or 212 suitable for the requested view to collect information on an object and to transmit the collected information on the object to the building monitoring view generator 206.

The object information collector by position 210 and the object information collector by equipment 212 extract and collect information from the database by position 112 and the database by equipment 112 the extracted information, respectively, and then transfer the collected information to the building monitoring view generator 206.

Thus, the building monitoring view generator 206 generates user friendly intuitive display information based on the received object information to transmit the generated display information to the user graphic output unit 208. The user graphic output unit 208 displays the same to the user 202.

Meanwhile, an object information collector by time 214 may be called and used when views by position and equipment are output from the building monitoring view generator 206 to be displayed to the remote building monitoring user 202; or when the information by time of the object to be monitored is referenced by the user 202.

Thus, the object information collector by time 214 collects the object information by time from the database by time 116 to transmit the collected object information to the building monitoring view generator 206.

The databases by position, equipment, and time 112, 114, and 116 may be connected with the respective object information collectors 210 to 214 by wire or wirelessly and may transmit and receive data information through a predetermined communication protocol 216 (e.g., BACnet, MODbus, LonWorks, TCP/IP, Zigbee, Serial COM, Bluetooth, UWB or the like).

FIG. 3 is a view illustrating an internal configuration of the database by position 112 in accordance with the embodiment of the present invention.

Referring to FIG. 3, the database by position 112 includes a floor table by building 302; each floor table by building 302 includes a zone table by floor 304; and each zone table by floor 304 includes an object table by zone 306. And each object table by zone 306 may include a day data table 308.

The floor table by building 302 classifies information on multiple buildings by building and manages the information by floor of each building as a main key.

The zone table by floor 304 divides each floor into segmentalized zones to manage the zones so that objects can be more systematically and correctly managed. The object table by zone 306 manages information on an object positioned in a segmentalized zone. Each object again stores a state value and a sensing value by time in the form of a table in the day data table 308.

Through such a configuration, various equipment information and sensing information and information on weather information objects can be simultaneously searched by the position of a building.

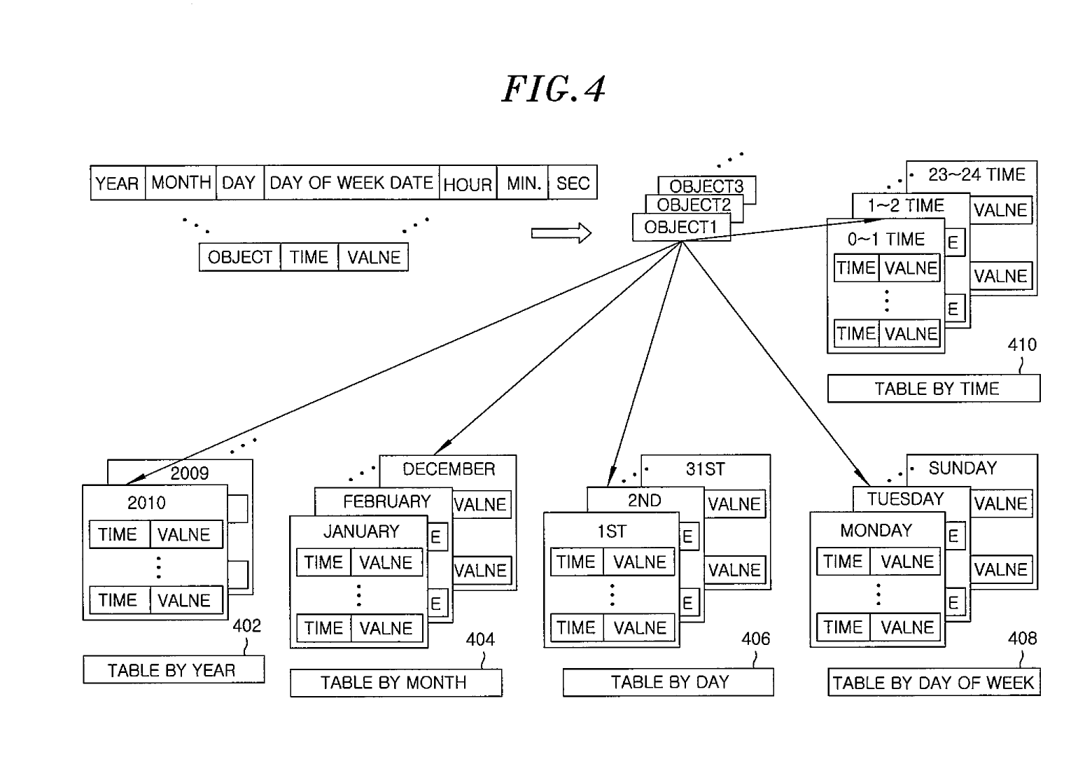

FIG. 4 is a view illustrating an internal configuration of the database by time 116 in accordance with the embodiment of the present invention

Referring to FIG. 4, time data on each object may be configured in a form of <year, month, day, day of week, hour, minute, and second> in the database by time 116, each data being classified by year and stored in a table by year 402; by month such as from January to December and stored in a table by month 404; by day and day of week such as from 1 to 31 and from Monday to Sunday and sequentially stored in a table by day 406 and a table by day of week 408, respectively.

In addition, the data may be classified by hour such as 0 to 1 o'clock, 1 to 2 o'clock, . . . , and 23 to 24 o'clock and stored in a table by time 410. In such storage of data, one object may be simultaneously stored in five classifications and utilized for various comparisons and analyses.

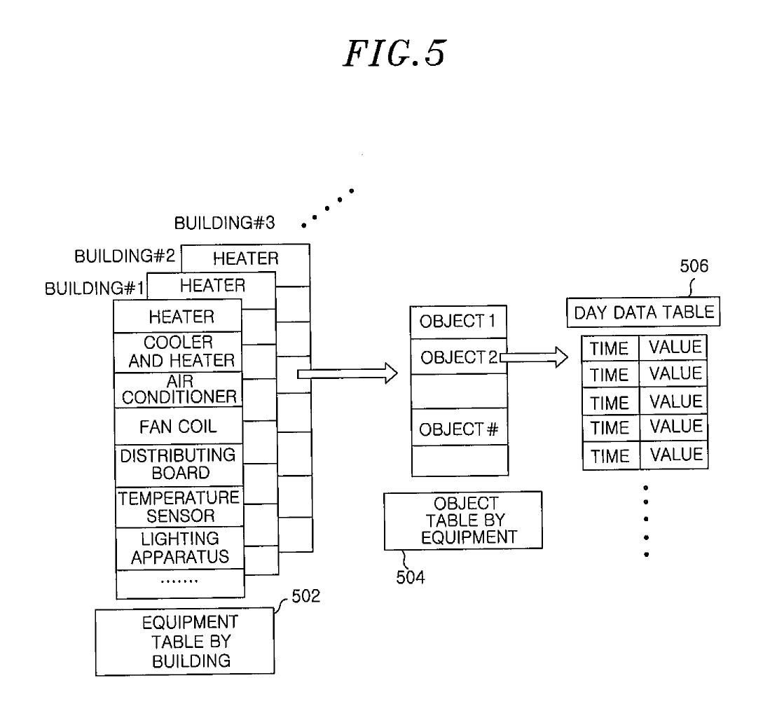

FIG. 5 is a view illustrating an internal configuration of the database by equipment 114 in accordance with the embodiment of the present invention.

Referring to FIG. 5, the database by equipment 114 stores equipment information established based on information on each building in an equipment table by building 502 and an object table by equipment 504 may store information on each of the objects corresponding to each equipment in the equipment table by building 502. Data of the day on each object may be stored in a form of a day data table 506 for the object table by equipment 504.

Since the table structures of the databases of FIGS. 3 to 5 are connected to each other, the data stored in each database can be stored in at least one table simultaneously corresponding to one object to be managed and an immediate response can be realized when data is requested by one object information collector.

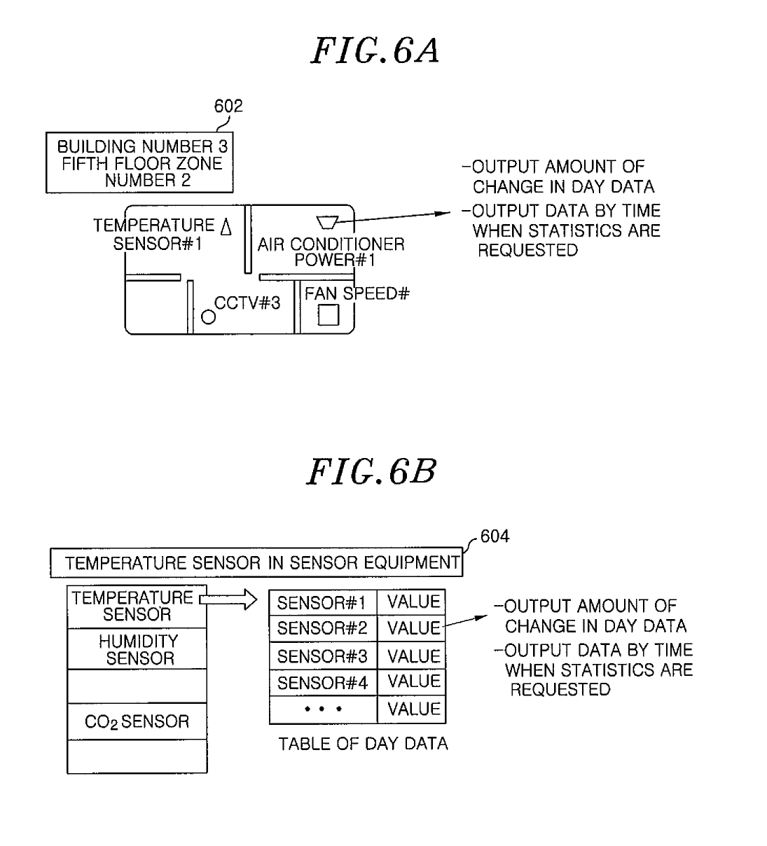

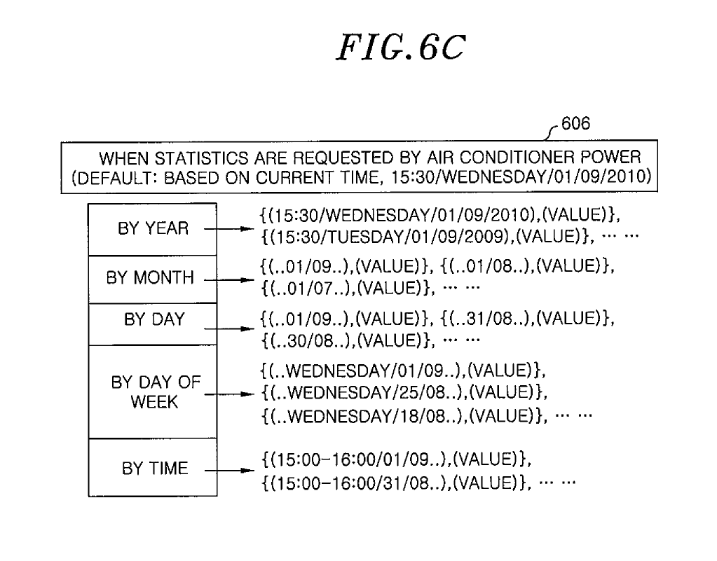

FIGS. 6A to 6C are views illustrating examples of a method of operating the building monitoring view generator 206 in the user interface processing apparatus in accordance with the embodiment of the present invention.

Referring to FIG. 6A, the building monitoring view generator 206 shows monitoring information regarding the building information by position of a building number 3—fifth floor-zone number 2 of an example 602. Monitoring of all of the objects that belong to the corresponding zone 2 may be simultaneously performed. The user 202 can refer the data by year, month, day, day of week, and time through the information database 116 by time when statistics are requested.

In FIG. 6B, an example 604 shows a building information monitoring example by equipment and provides information on all of the sensor objects that belong to the temperature sensor.

Further, in FIG. 6C, when statistics are requested by air conditioner power, an example 606 may provide, e.g., data of an amount of change in the air conditioner power, by year, month, day, day of week, and time based on current time when statistic information on an object is requested and when there is no addition search time.

That is, the building monitoring view generator 206 displays an amount of change in data of the day of a target object by zone or equipment and outputs object statistic information by time in response to a user statistic request. Also, when object information by time is requested, the object information may be compared by year, by month, by day, by day of week, and by time to be output.

As a result, in the method and apparatus for establishing the database and processing the user interface in accordance with the embodiment of the present invention, multiple building data can be hierarchically stored in order to provide a high performance view and an analyzing screen and various monitoring points are generalized through object concept to provide consistent and intuitive monitoring and analysis opportunities to a remote building control center operator.

In addition, since data can be variously utilized in terms of comparison by building and in terms of time and space, the buildings can be effectively analyzed.

While the invention has been shown and described with respect to the particular embodiments, it will be understood by those skilled in the art that various changes and modification may be made without departing from the scope of the invention as defined in the following claims.

What is claimed is:

1. An apparatus for establishing a database and processing a user interface for monitoring building information in a remote building control system, the apparatus comprising:
a database establishing apparatus for receiving building information collected from at least one building and analyzing the received information and storing the building information in respective databases by position, equipment, and time; and
a user interface processing apparatus for collecting object information from the respective databases in response to an inputted monitoring request to generate display information based on the collected object information to output the generated display information.

2. The apparatus of claim 1, wherein the collected building information includes building equipment information, environment sensor information, and weather information, each information having at least one of object information, position information, time information, and a state value.

3. The apparatus of claim 1, wherein the database establishing apparatus includes:
a building information receiver for converting the building information received from said at least one building to has at least one of object information, position information, time information, and a state value; and
a building information analyzer for analyzing the building information to classify the information into a position, an equipment, and a time thereby to store the analyzed building information in the respective databases.

4. The apparatus of claim 1, wherein the database by position includes at least one of a floor table structure by building, a zone table structure by floor, an object table structure by region, and a day data table structure by object, and
wherein the table structures are connected to each other to simultaneously store object data.

5. The apparatus of claim 1, wherein the database by time includes at least one of a table structure by year, a table structure by month, a table structure by day, and a table structure by day of week, and
wherein the table structures are connected to each other to simultaneously store object data.

6. The apparatus of claim 1, wherein the database by equipment includes at least one of an equipment table structure by building, an object table structure by equipment, and a day data table structure by object, and
wherein the table structures are connected to each other to simultaneously store object data.

7. The apparatus of claim 1, wherein the user interface processing apparatus includes:
a user input processor for generating a control command based on an input monitoring request;
at least one object information collector for collecting object information from the respective databases based on the control command;
a building monitoring view generator for receiving the collected object information to generate display information corresponding to the monitoring request; and
a user graphic output unit for outputting the display information in a graphical form.

8. The apparatus of claim 7, wherein the building monitoring view generator displays an amount of change in day data of a target object by region or equipment and outputs object statistic information by time in response to an input statistic request.

9. The apparatus of claim 7, wherein when object information by time is requested, the building monitoring view generator compares the object information by year, by month, by day, by day of week, and by time to be outputted.

10. A method for establishing a database and processing a user interface for monitoring building information in a remote building control system, the method comprising:
receiving, at a database establishing apparatus, building information collected from at least one building and analyzing the received information and storing the building information in respective databases by position, equipment, and time; and
collecting, at a user interface processing apparatus, object information from the respective databases in response to an inputted monitoring request to generate display information based on the collected object information, and outputting the generated display information.

11. The method of claim 10, wherein the collected building information includes building equipment information, environment sensor information, and weather information, each information having at least one of object information, position information, time information, and a state value.

12. The method of claim 10, wherein said storing the building information in respective databases includes:
converting the building information received from said at least one building to include at least one of object information, position information, time information, and a state value; and
analyzing the converted building information to classify the information into a position, an equipment, and a time to thereby store the analyzed building information in the respective databases.

13. The method of claim 10, wherein the database by position includes at least one of a floor table structure by building, a zone table structure by floor, an object table structure by region, and a day data table structure by object, and
wherein the table structures are connected to each other to simultaneously store object data.

14. The method of claim 10, wherein the database by time includes at least one of a table structure by year, a table structure by month, a table structure by day, and a table structure by day of week, and
wherein the table structures are connected to each other to simultaneously store object data.

15. The method of claim 10, wherein the database by equipment includes at least one of an equipment table structure by building, an object table structure by equipment, and a day data table structure by object, and
wherein the table structures are connected to each other to simultaneously store object data.

16. The method of claim 10, wherein said outputting the generated display information includes:
generating a control command based on an input monitoring request;
collecting object information from the respective databases based on the control command;
receiving the collected object information to generate display information corresponding to the monitoring request; and
outputting the display information in a graphical form.

17. The method of claim 16, wherein said receiving the collected object information displays an amount of change in day data of a target object by a region or an equipment and outputs object statistic information by a time in response to an inputted statistic request.

18. The method of claim 16, wherein when object information by time is requested, in said receiving the collected object information, the object information is compared by year, by month, by day, by day of week, and by time to be outputted.
